(19) United States
(12) Patent Application Publication
(10) Pub. No.: US 2013/0004671 A1
(43) Pub. Date: Jan. 3, 2013

(54) STAIN BLOCKING COMPOSITIONS INCLUDING AN ALKYL AMIDE

(75) Inventors: Jacob Wildeson, Chambersburg, PA (US); John Kelly, Charlotte, NC (US)

(73) Assignee: BASF SE, Ludwigshafen (DE)

(21) Appl. No.: 13/521,356

(22) PCT Filed: Jan. 28, 2011
(86) PCT No.: PCT/EP2011/051198

§ 371 Date: Jul. 10, 2012

Related U.S. Application Data
(60) Provisional application No. 61/300,873, filed on Feb. 3, 2010.

(51) Int. Cl. C09D 177/12; C09D 133/02; C09D 133/08; C09D 133/14; C09D 133/12; C09D 143/04; C09D 145/00; C08K 5/523; C08K 5/09; C08K 5/05; C09D 147/00; C09D 133/26; C09D 133/20; B05D 7/00; C08K 3/20

(52) U.S. Cl. 427/385.5; 524/607; 524/588; 524/560; 524/561; 524/558; 524/555; 524/547; 524/562; 524/548; 524/151; 524/300; 524/391

(57) ABSTRACT

An aqueous coating composition for blocking stains and a method of using the coating composition are described. The coating composition includes an aqueous dispersion of a co-polymer that is derived from an emulsion polymerization of an ethylenically unsaturated non-ionic monomer, an ethylenically unsaturated monomer with a functional acid group having a pKa of 2 or greater or salt thereof, and an alkyl amide.

### BACKGROUND

Stain blocking coating compositions (e.g., primers) are often applied to the surfaces of coated or uncoated substrates to promote adhesion and to serve as a barrier to underlying polar or non-polar compounds that may act as staining agents. However, given the solvent properties of water- and oil-based coatings, staining agents often leach from the substrate into and/or through the coating while the coating is still wet, i.e., the agents become solvated and diffuse into the coating, causing surface discoloration of the coating. For example, tannins contained in redwood, cedar, elm, merbau, and mahogany can leach from such a wood substrate into a coating, causing tannin staining, which appears as discoloration on the surface of the coating. Localized stains or discoloration also can become visible when staining agents present (but previously not visible) in coated substrates are activated by exposure of the substrate to water or humidity. These types of staining are highly undesirable in coatings.

### SUMMARY

An aqueous coating composition for blocking stains is provided. The aqueous coating composition includes an aqueous dispersion comprising a copolymer derived from an emulsion polymerization of an ethylenically unsaturated nonionic monomer, an ethylenically unsaturated monomer with a functional acid group having a pKa of 2 or greater or salt thereof, and optionally an alkyl amide with the following formula:

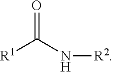

In the alkyl amide, R¹ is a substituted or unsubstituted C₇ to C₁₇ linear alkyl, alkenyl, alkynyl, or substituted or unsubstituted C₇-C₁₇ linear heteroalkyl, and R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or

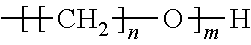

Wherein n is 2 to 3, m is 2 to 10, and if the alkyl amide is omitted from the emulsion polymerization, the alkyl amide is added to the aqueous coating composition after the emulsion polymerization. The alkyl amide can, for example, be lauramide.

A method for blocking a stain is also provided. The method for blocking stains includes the steps of forming an aqueous coating composition comprising a copolymer derived from an emulsion polymerization of an ethylenically unsaturated nonionic monomer, an ethylenically unsaturated monomer with a functional acid group having a pKa of 2 or greater or salt thereof, and optionally an alkyl amide with the following formula:

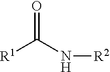

In the alkyl amide, R¹ is a substituted or unsubstituted C₇ to C₁₇ linear alkyl, alkenyl, alkynyl, or substituted or unsubstituted C₇-C₁₇ linear heteroalkyl, and R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or

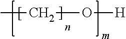

wherein n is 2 to 3, m is 2 to 10, and if the alkyl amide is omitted from the emulsion polymerization, the alkyl amide is added to the aqueous coating composition after the emulsion polymerization. Next the aqueous coating composition is applied to a substrate having a stain. Then the aqueous coating composition is dried or allowed to dry.

The details of one or more examples of these compositions and methods are set forth in the description below. Other features, objects, and advantages will be apparent from the description and from the claims.

### DETAILED DESCRIPTION

Aqueous coating compositions for blocking stains are described herein. These aqueous coating compositions include an aqueous dispersion. The aqueous dispersion includes a copolymer that is derived from an emulsion polymerization of an ethylenically unsaturated nonionic monomer, an ethylenically unsaturated monomer with a functional acid group having a pKa of 2 or greater or salt thereof, and optionally an alkyl amide with the following formula:

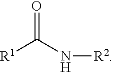

If the alkyl amide is not present during the emulsion polymerization, it is added to the aqueous coating composition after the emulsion polymerization, i.e., added to the aqueous dispersion after the emulsion polymerization or added to an aqueous coating composition containing the aqueous dispersion, e.g., a paint product, after formulation. In the alkyl amide, R¹ is a substituted or unsubstituted C₇ to C₁₇ linear alkyl, alkenyl, alkynyl, or substituted or unsubstituted C₇-C₁₇ linear heteroalkyl, and R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or

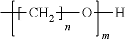

wherein n is 2 to 3, and m is 2 to 10. Additionally, m can be 2 to 8, or m can be 2 to 6.

As used herein the term stain includes any mark, blemish, discoloration, or deposit, whether or not visible or readily apparent to the naked eye. The term stain thus includes, but is not limited to, marks caused by inks, crayons, lipstick, grease pencils, smoke residue, tannins, water extracts, and the like. Stains may be found, for example, on residential or commercial walls as graffiti, markings from pens or color markers, on or native to wooden substrates, on wood-composite substrates, on concrete substrates, on paper substrates (such as wall board coverings), and on other substrates that are normally painted with one or more liquid coatings.

As used herein the term stain blocking is intended to mean binding, blocking or masking a stain where it cannot be seen, or is substantially less visible, once one or more liquid coatings are applied and dried, or in those cases where the stain is not visible or only slightly visible, that the stain cannot migrate through the one or more subsequently applied and dried liquid coatings.

Suitable ethylenically unsaturated nonionic monomers include any monomers or monomer residues that have no pendant acid or base group. Representative examples of suitable ethylenically unsaturated nonionic monomers include alkyl esters of acrylic acid (alkyl acrylates) or methacrylic acid (alkyl methacrylate) such as methyl acrylate or methyl methacrylate, ethyl acrylate or ethyl methacrylate, butyl acrylate or butyl methacrylate, 2-ethylhexyl acrylate or 2-ethylhexyl methacrylate, cyclohexyl acrylate or cyclohexyl methacrylate, octyl acrylate or octyl methacrylate, decyl acrylate or decyl methacrylate, isodecyl acrylate or isodecyl methacrylate, lauryl acrylate or lauryl methacrylate, oleyl acrylate or oleyl methacrylate, palmityl acrylate or palmityl methacrylate, stearyl acrylate or stearyl methacrylate, hydroxyethyl acrylate or hydroxyethyl methacrylate, and hydroxypropyl acrylate or hydroxypropyl methacrylate; acrylonitrile or methacrylonitrile; acrylamide or methacrylamide; amino-functional monomers such as dimethylaminoethyl acrylate or dimethylaminoethyl methacrylate; ureido-functional monomers such as N-(2-methacryloyloxyethyl)ethylene urea; silane-functional monomers such as methacryloxypropyltrimethoxy silane and vinyltriacetoxysilane; styrene and substituted styrenes; butadiene; ethylene; propylene; α-olefins such as 1-decene, vinyl acetate, vinyl versatate, vinyl butyrate and other vinyl esters; vinyl monomers such as vinyl chloride, vinyl toluene, vinyl naphthalene and vinyl benzophenone; and vinylidene chloride; and combinations thereof. The selection of particular ethylenically unsaturated nonionic monomers can be based on reaching a target glass transition temperature or to provide other desired properties to the copolymer.

The ethylenically unsaturated nonionic monomer can include one or more alkyl acrylates. For example, the ethylenically unsaturated nonionic monomer can include 2-ethylhexyl acrylate and can optionally further include butyl acrylate. For further example, the ethylenically unsaturated nonionic monomer can include styrene and one or more alkyl acrylates. Additionally, the ethylenically unsaturated nonionic monomer can include vinyl acetate and one or more alkyl acrylates.

The ethylenically unsaturated nonionic monomer can include monomers having functional pendant groups which promote wet adhesion onto various substrates. These groups can include, but are not limited to, amino, silane, imidazole, acetoacetonate, imidazolidone, diamine, urea and ureido functional groups. For example, the functional monomer can be a ureido-functional monomer such as N-(2-methacryloyloxyethyl)ethylene urea.

Suitable ethylenically unsaturated monomers with a functional acid group having a pKa (in water at 20° C.) of 2 or greater or salts of such monomers. Suitable salts of acid monomers include ammonium, sodium, potassium and lithium salts. Examples of ethylenically unsaturated monomers with a functional acid group having a pKa (in water at 20° C.) of 2 or greater or salts thereof include, but are not limited to, acrylic acid, methacrylic acid, crotonic acid, itaconic acid, fumaric acid and maleic acid; monomethyl itaconate; monomethyl fumarate; monobutyl fumarate; maleic anhydride; acrylamide or substituted acrylamides; diacetone acrylamide; glycidal methacrylate; acetoacetyl ethylmethacrylate; acrolein and methacrolein; dicyclopentadienyl methacrylate; dimethyl meta-isopropenyl benzyl isocyanate, isocyanato ethylmethacrylate; styrene or substituted styrenes; butadiene; ethylene, vinyl acetate or other vinyl esters; vinyl monomers, such as, for example, vinyl chloride, vinylidene chloride, N-vinyl pyrrolidone; amino monomers, such as, for example, N,N′-dimethylamino (meth)acrylate and acrylonitrile or methacrylonitrile; and combinations thereof.

The compositions can additionally include ethylenically unsaturated strong acid monomers including monomers that have a pendant acid group with a pKa (in water at 20° C.) of less than 4 or salts of such monomers. Suitable salts of acid monomers include ammonium, sodium, potassium and lithium salts. Representative examples of suitable ethylenically unsaturated strong acid monomers or salts thereof include 2-acrylamido-2-methylpropane sulfonic acid; 1-allyloxy-2-hydroxypropane sulfonic acid; vinylsulfonic acid; styrene sulfonic acid; alkyl allyl sulfosuccinic acid; sulfoethyl acrylate or sulfoethyl methacrylate; phosphoalkyl acrylates or phosphoalkyl methacrylates such as phosphoethyl acrylate or phosphoethyl methacrylate, phosphopropyl acrylate or phosphopropyl methacrylate, phosphobutyl acrylate or phosphobutyl methacrylate, phosphate ester of polyethyleneglycol acrylate or polyethyleneglycol methacrylate and phosphate ester of polypropyleneglycol acrylate or polypropyleneglycol methacrylate; phosphoalkyl crotonates; phosphoalkyl maleates; phosphoalkyl fumarates; phosphodialkyl acrylates or phosphodialkyl methacrylates; phosphodialkyl crotonates; allyl phosphate; and combinations thereof. The compositions described herein can utilize ethylenically unsaturated monomers with a functional acid group that are not phosphate based.

The copolymer as described herein can be prepared using from greater than 0% to about 5% by weight of an ethylenically unsaturated monomer with a functional acid group (e.g., methacrylic acid). For example, the copolymer can be prepared using from about 0.5% to about 4% by weight of an ethylenically unsaturated monomer with a functional acid group (e.g., methacrylic acid).

The copolymer as described herein can have a glass transition temperature (Tg) of about 0° C. to about 45° C. Glass transition temperature can be measured using differential scanning calorimetry.

As described above, the alkyl amides include alkyl amides with the following formula:

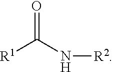

In the alkyl amides useful with the coating compositions described herein, R¹ is a substituted or unsubstituted C₇ to C₁₇ alkyl, alkenyl, alkynyl, or substituted or unsubstituted C₇-C₁₇ linear heteroalkyl. R¹ can also be a substituted or unsubstituted C₁₁ to C₁₃ alkyl, or substituted or unsubstituted C₁₁-C₁₃ heteroalkyl. Additionally, R¹ can be a substituted or unsubstituted C₁₁ alkyl, or substituted or unsubstituted C₁₁ heteroalkyl.

Also, in the alkyl amides useful with the coating compositions described herein, R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or

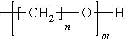

wherein n is 2 to 3, and m is 2 to 10. Additionally, m can be 2 to 8, or m can be 2 to 6. R² can also be a substituted or unsubstituted C₁-C₂ alkyl, or substituted or unsubstituted C₁-C₂ heteroalkyl.

Specific examples of alkyl amides include lauramide (structure A),

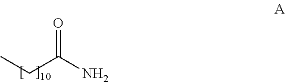

n-methyl lauramide (structure B),

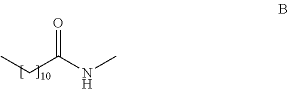

n-ethoxy lauramide (structure C), and

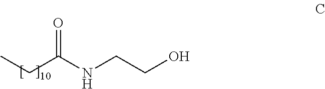

multiple n-ethoxylated lauramides (see, e.g., structure D).

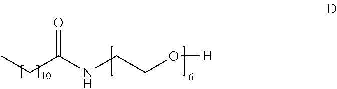

As used herein, unless otherwise specified, the terms alkyl, alkenyl, and alkynyl include linear- and branched-chain monovalent substituents. Examples include methyl, ethyl, isobutyl, 3-butynyl, and the like. Heteroalkyl, heteroalkenyl, and heteroalkynyl are similarly defined but may contain O, S, or N heteroatoms or combinations thereof within the backbone. The alkyl, alkenyl, alkynyl, heteroalkyl, heteroalkenyl, and heteroalkynyl molecules used herein can be substituted or unsubstituted. As used herein, the term substituted includes the addition of an alkyl, alkenyl, alkynyl, cycloalkyl, aryl, heteroalkyl, heteroalkenyl, heteroalkynyl, heterocycloalkyl, or heteroaryl group to a position attached to the main (linear or branched) chain of the alkyl, alkenyl, alkynyl, heteroalkyl, heteroalkenyl, or heteroalkynyl, e.g., the replacement of a hydrogen by one of these molecules. Examples of substitution groups include, but are not limited to, hydroxyl, halogen (e.g., F, Br, Cl, or I), amino, and carboxyl groups. Conversely, as used herein, the term unsubstituted indicates the alkyl, alkenyl, alkynyl, heteroalkyl, heteroalkenyl, or heteroalkynyl has a full complement of hydrogens, i.e., commensurate with its saturation level, with no substitutions, e.g., linear decane (—(CH₂)₉—CH₃).

The compounds described herein can be prepared in a variety of ways. The compounds can be synthesized using synthetic methods known in the art of synthetic organic chemistry or variations thereon as appreciated by those skilled in the art. The compounds described herein can be prepared from readily available starting materials. Optimum reaction conditions may vary with the particular reactants or solvent used, but such conditions can be determined by one skilled in the art by routine optimization procedures.

Variations on the compounds described herein include the addition, subtraction, or movement of the various constituents as described for each compound. Similarly, as described above, when one or more chiral centers is present in a molecule the chirality of the molecule can be changed. Additionally, compound synthesis can involve the protection and deprotection of various chemical groups. The use of protection and deprotection, and the selection of appropriate protecting groups can be determined by one skilled in the art. The chemistry of protecting groups can be found, for example, in Wuts and Greene, Protective Groups in Organic Synthesis, 4^{th} Ed., Wiley & Sons, 2006, which is incorporated herein by reference in its entirety.

Reactions to produce the compounds described herein can be carried out in solvents that can be selected by one of skill in the art of organic synthesis. Solvents can be substantially nonreactive with the starting materials (reactants), the intermediates, or products under the conditions at which the reactions are carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹ H or ¹³C) infrared spectroscopy, spectrophotometry (e.g., UV-visible), or mass spectrometry, or by chromatography such as high performance liquid chromatography (HPLC) or thin layer chromatography.

The aqueous copolymer dispersion can be prepared by polymerizing the monomer components using free-radical aqueous emulsion polymerization. The emulsion polymerization can be performed in a single stage or in multiple stages (e.g., to produce a core/shell polymer particle). The emulsion polymerization temperature is generally from about 30° C. to about 95° C. or from about 70° C. to about 90° C. The polymerization medium can include water alone or a mixture of water and water-miscible liquids, such as methanol. The emulsion polymerization can be carried out either as a batch process, semi-batch process, or continuous process, including a step or gradient procedure. For example, a feed process can be used in which part of the polymerization batch is heated to the polymerization temperature and partially polymerized, and the remainder of the polymerization batch is subsequently fed to the polymerization zone continuously, in steps or with superposition of a concentration gradient, usually via a plurality of spatially separate feed streams, of which one or more contain the monomers in pure or emulsified form, while maintaining the polymerization.

The initially introduced mixture and/or the monomer feed stream can contain small amounts of surfactants, generally less than about 0.5% by weight, based on the total amount of monomers to be polymerized. Representative examples of suitable surfactants include alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; alcohols or phenols, and combinations thereof. These surfactants can in many cases be alkoxylated, and are typically ethoxylated using ethylene oxide. For example, the surfactants can include at least one anionic surfactant, at least one nonionic surfactant, or a combination thereof For example, nonionic alkoxylated carboxylic acids or alcohols having from 8 to 24 carbon atoms (e.g. 12 or 16 carbon atoms) and/or anionic aryl (e.g. tristyryl) phenol phosphates can be used in the aqueous composition. The monomers can be fed to the polymerization zone after pre-emulsification with these assistant surfactants. One or more of the surfactants can also be added after polymerization.

Free-radical emulsion polymerization can be carried out in the presence of a free-radical polymerization initiator. The free-radical polymerization initiators that can be used in the process are all those which are capable of initiating a free-radical aqueous emulsion polymerization including alkali metal peroxydisulfates and H₂O₂, or azo compounds. Combined systems can also be used comprising at least one organic reducing agent and at least one peroxide and/or hydroperoxide, e.g., tert-butyl hydroperoxide and the sodium metal salt of hydroxymethanesulfinic acid or hydrogen peroxide and ascorbic acid. Combined systems can also be used additionally containing a small amount of a metal compound which is soluble in the polymerization medium and whose metallic component can exist in more than one oxidation state, e.g., ascorbic acid/iron(II) sulfate/hydrogen peroxide, where ascorbic acid can be replaced by the sodium metal salt of hydroxymethanesulfinic acid, sodium sulfite, sodium hydrogen sulfite or sodium metal bisulfite and hydrogen peroxide can be replaced by tert-butyl hydroperoxide or alkali metal peroxydisulfates and/or ammonium peroxydisulfates. In general, the amount of free-radical initiator systems employed is from about 0.1 to about 2% by weight, based on the total amount of the monomers to be polymerized. For example, the initiators can be ammonium and/or alkali metal peroxydisulfates (e.g. sodium peroxydisulfates), alone or as a constituent of combined systems.

The manner in which the free-radical initiator system is added to the polymerization reactor during the free-radical aqueous emulsion polymerization can be varied. For example, all the initiator can be introduced into the polymerization reactor at the beginning, or the initiator can be added continuously or stepwise as it is consumed during the free-radical aqueous emulsion polymerization. The choice of an introduction method will depend both upon the chemical nature of the initiator system and on the polymerization temperature, factors that are well known to those of skill in the art. As an example, a partial dose of initiator can be introduced at the beginning of a reaction and the remainder of the initiator can be added to the polymerization zone as the first dose is consumed. The free-radical aqueous emulsion polymerization cab be carried out under superatmospheric or reduced pressure.

Chain transfer agents may be used to control the molecular weight of the emulsion copolymer. Examples of chain transfer agents include halogen compounds such as tetrabromomethane; allyl compounds; and mercaptans such as alkyl thioglycolates, alkyl mercaptoalkanoates such as isooctyl mercaptopropionate, and C₄-C₂₂ linear or branched alkyl mercaptans such as t-dodecyl mercaptan. One or more chain transfer agents may be added in one or more additions or continuously (linearly or non-linearly) over most or all of the reaction period or during one or more limited portions of the reaction period. In general, the amount of chain transfer agents used is less than about 5% by weight, based on the total amount of the monomers to be polymerized.

The aqueous dispersions can be prepared with total solids contents of from 10 to 75% by weight, 15 to 65% by weight, or 20 to 60% by weight. The aqueous dispersions can then be concentrated if desired to provide a total solids content of 40-75% by weight. The aqueous dispersions can be converted to redispersible polymer powders (e.g., spray drying, roll drying or suction-filter drying) by methods known to those of skill in the art. If an aqueous dispersion is to be dried, drying aids can be used. Such dried dispersions have a long shelf life and can be redispersed in water for use in the aqueous coating compositions.

The aqueous dispersions can be mixed with other components, such as polymeric binders, thickeners, fillers, pigments, dyes, and other additives. The order of mixing is not critical although enough water needs to be present in the composition for the addition of solid components such as certain fillers. The aqueous coating compositions as described herein can be formulated with a pigment composition of about 3% to about 70% by volume. The aqueous coating compositions can be formulated with or without the pigment ZnO.

The aqueous coating composition may be applied by any suitable methods such as, for example, brushing and spraying methods. Examples of brushing and spraying methods include roll coating, doctor-blade application, printing methods, air-atomized spray, air-assisted spray, airless spray, high volume low pressure spray, and air-assisted airless spray.

The aqueous coating compositions described herein preferably have a pH near neutral and contain no permanent base components. More preferably, the aqueous coating compositions described herein have an acidic pH.

In a method for blocking stains, the aqueous coating compositions as described above may be applied (also as described above) to a substrate having or suspected of having a stain. Examples of substrates suitable for use with the methods and aqueous coating compositions described herein include metal, wood, wood composites, concrete, paper (e.g., wall board coverings), and other substrates that are normally painted with one or more liquid coatings. The substrate can be a primed surface or a previously painted surface. The aqueous coating composition on the substrate may be dried or allowed to dry. The aqueous coating composition can be dried with or without heating.

### EXAMPLE

A commercial control, Acronal® NX4641 (BASF Corporation; Florham Park, N.J.) and a stain blocking latex prototype containing structure D as described above were compared in a primer formulation of 32% PVC, 100 g/L VOC containing no zinc oxide.

A high quality commercially available all acrylic interior flat paint (film A) was cast onto a white scrub chart form P122-10N (The Leneta Company, Inc.; Mahwah, N.J.). The dry thickness of film A was between 3-4 mils. The paint film was allowed to cure for at least 7 days.

A wide, even band of sharpie permanent black (stain 1) was then applied perpendicular to the acrylic flat paint film A. The total width of the stain 1 band was at least 1 inch. A wide, even band of CRAYOLA® washable green window marker (stain 2) (CRAYOLA LLC; Easton, Pa.) was also applied perpendicular to the acrylic flat paint film A and at least 3 inches below the stain 1 band. The total width of the stain 2 band was also at least 1 inch. The stain 1 and stain 2 bands were allowed to dry for at least 24 hrs.

The commercial control primer and the prototype primer were then applied over both stain 1 and stain 2 at approximately 3.5 mils wet film thickness. The primers were applied simultaneously in a side by side arrangement for ease of visual and spectrometric comparison. The primers were allowed to dry for 3 hours.

The paint used for film A was re-applied over the composite panel at a wet film thickness of approximately 5 mils (film B). This panel was then allowed to dry overnight.

Total color difference readings (AE) were then measured using an X-Rite SP64 Portable Sphere Spectrophotometer (RPImaging; Tucson, Ariz.) by fixing an unstained portion of film B as the color blank or standard, followed by reading the subsequent stained portions of the primers against the standard. Known in the art—delta E is the total color difference as derived from equations that transform CIE chromaticity coordinates into a more uniform matrix such that a specified difference between two colors is more nearly proportional to the magnitude of an observed difference between them regardless of their hue.

The results were:

| | ΔE | ΔE CRAYOLA ® |
|---|---|---|
| | Sharpie | Green Marker |
| Acronal ® NX4641 Control | 0.91 | 4.91 |
| Stain Blocking Composition | 0.85 | 3.91 |

The compositions and methods of the appended claims are not limited in scope by the specific compositions and methods described herein, which are intended as illustrations of a few aspects of the claims and any compositions and methods that are functionally equivalent are within the scope of this disclosure. Various modifications of the compositions and methods in addition to those shown and described herein are intended to fall within the scope of the appended claims. Further, while only certain representative compositions and methods and aspects of these compositions and methods are specifically described, other methods are intended to fall within the scope of the appended claims. Thus, a combination of steps, elements, components, or constituents may be explicitly mentioned herein; however, all other combinations of steps, elements, components, and constituents are included, even though not explicitly stated. The term “comprising” and variations thereof as used herein are used synonymously with the term “including” and variations thereof and are open, non-limiting terms.

What is claimed is:

1. An aqueous coating composition for blocking a stain, comprising:
an aqueous dispersion comprising a copolymer derived from an emulsion polymerization of an ethylenically unsaturated nonionic monomer, an ethylenically unsaturated monomer with a functional acid group having a pKa of 2 or greater or salt thereof, and optionally an alkyl amide with the following formula: 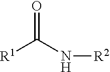
wherein R¹ is a substituted or unsubstituted C₇ to C₁₇ linear alkyl, alkenyl, alkynyl, or substituted or unsubstituted C₇-C₁₇ linear heteroalkyl, and R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or 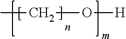
wherein n is 2 to 3, m is 2 to 10, and if the alkyl amide is omitted from the emulsion polymerization, the alkyl amide is added to the aqueous coating composition after the emulsion polymerization.

2. The composition according to claim 1, wherein the alkyl amide is present during the emulsion polymerization.

3. The composition according to claim 1, wherein the alkyl amide is added to the aqueous dispersion after the emulsion polymerization.

4. The composition according to claim 1, wherein the alkyl amide is added to the aqueous coating composition containing the aqueous dispersion.

5. The composition according to claim 1, wherein the ethylenically unsaturated nonionic monomer comprises an alkyl acrylate.

6. The composition according to claim 1, wherein the ethylenically unsaturated nonionic monomer comprises styrene.

7. The composition according to claim 1, wherein the ethylenically unsaturated nonionic monomer comprises vinyl acetate.

8. The composition according to claim 1, wherein the ethylenically unsaturated nonionic monomer comprises a monomer having a functional pendant group.

9. The composition according to claim 8, wherein the functional pendant group comprises one or more of amino, silane, imidazole, acetoacetonate, imidazolidione diamine, urea, and ureido functional groups.

10. The composition according to claim 1, wherein R¹ is a substituted or unsubstituted C₁₁-C₁₃ alkyl, or substituted or unsubstituted C₁₁-C₁₃ heteroalkyl.

11. The composition according to claim 1, wherein R¹ is a substituted or unsubstituted C₁₁ alkyl, or substituted or unsubstituted C₁₁ heteroalkyl.

12. The composition according to claim 1, wherein R² is a substituted or unsubstituted C₁-C₂ alkyl, or substituted or unsubstituted C₁-C₂ heteroalkyl.

13. The composition according to claim 1, wherein the alkyl amide is lauramide.

14. The composition according to claim 1, wherein the alkyl amide is N-methyl lauramide.

15. The composition according to claim 1, wherein the alkyl amide is N-ethoxy lauramide.

16. The composition according to claim 1, wherein the alkyl amide is

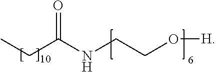

17. The composition according to claim 1, wherein the ethylenically unsaturated monomer with a functional acid group comprises methacrylic acid.

18. The composition according to claim 1, wherein the ethylenically unsaturated monomer with a functional acid group comprises greater than 0% to 5% of the composition.

19. The composition according to claim 1, wherein the ethylenically unsaturated monomer with a functional acid group comprises 0.5% to 4% of the composition.

20. The composition according to claim 1, further comprising one or more surfactants.

21. The composition according to claim 20, wherein the one or more surfactants include a tristyrylphenol phosphate.

22. The composition according to claim 20, wherein the one or more surfactants include a nonionic alkoxylated carboxylic acid or alcohol having from 8 to 24 carbon atoms.

23. The composition according to claim 1, wherein the copolymer has a glass transition temperature (Tg) from 0° C. to 45° C.

24. A method for blocking stains, comprising:
(a) forming an aqueous coating composition comprising a copolymer derived from an emulsion polymerization of an ethylenically unsaturated nonionic monomer, an ethylenically unsaturated monomer with a functional acid group having a pKa of 2 or greater or salt thereof, and optionally an alkyl amide with the following formula: 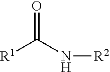
wherein R¹ is a substituted or unsubstituted C₇ to C₁₇ linear alkyl, alkenyl, alkynyl, or substituted or unsubstituted C₇-C₁₇ linear heteroalkyl, and R² is hydrogen, substituted or unsubstituted C₁-C₆ alkyl, substituted or unsubstituted C₁-C₆ heteroalkyl, substituted or unsubstituted C₂-C₆ alkenyl, substituted or unsubstituted C₂-C₆ heteroalkenyl, substituted or unsubstituted C₂-C₆ alkynyl, substituted or unsubstituted C₂-C₆ heteroalkynyl, or 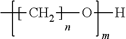
wherein n is 2 to 3, m is 2 to 10, and if the alkyl amide is omitted from the emulsion polymerization, the alkyl amide is added to the aqueous coating composition after the emulsion polymerization;
(b) applying the aqueous coating composition to a substrate having a stain; and
(c) drying the aqueous coating composition, or allowing the aqueous coating composition to dry.
